(19) United States
(12) Patent Application Publication
(10) Pub. No.: US 2004/0261014 A1
(43) Pub. Date: Dec. 23, 2004

(54) Case editing system and method

(76) Inventors: Chung-I Lee, Tu-chen (TW); Bao Sheng Luo, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/873,891

(22) Filed: Jun. 21, 2004

(30) Foreign Application Priority Data
Jun. 20, 2003 (TW) 92116773

(51) Int. Cl. G06F 15/00

(52) U.S. Cl. 715/511

(57) ABSTRACT

An case editing system according to a preferred embodiment of the present invention includes a database server (1) for storing files used or generated in implementing the case editing system; an application server (2), and a number of client computers (4) for users of the case editing system to carry out case edit operations via a communication networks. The application server (2) includes a number of software function modules for maintaining edit processes, for assigning and canceling access authorities to different editors and writers, for transmitting messages to various editors and writers, for enabling the editors to edit the case files, for recording edit results in an edit record file, and for enabling the writers to revise the case files. A related method for case editing is also disclosed.

### BACKGROUND OF THE INVENTION

1. Field of the Invention

The present invention relates generally to systems and methods for electronic management of cases such as those handled by a professional office on behalf of clients, and more particularly to a case editing system and method for editors to edit case files and for writers to revise the case files when the editors and writers are located at different places.

2. Background of the Invention

For professional offices, such as law offices and accounting firms, efficient case management is very important. The efficiency of managing cases directly affects actual completion times and the quality of results of the cases. Traditionally, most procedures of case management are handled manually. Manual procedures are generally time-consuming, and the corresponding labor costs can be high. For example, case managers may have to spend much time in querying historical case records, in order to assign suitable personnel to process a new case. With the recent development of computer science and network technology, case management methods based on an intranet are becoming more and more popular in professional offices because of their relatively simple processes, lower error rates and lower costs. A typical professional document such as a contract must be written according to predefined specifications, and a draft thereof is usually repeatedly edited by skilled editors and revised by the original writer. Existing computerized case management systems generally can not provide an efficient common platform for assisting editors and writers in respectively editing and revising the drafts, especially when the editors and writers are located at different places within the professional office or in different branch offices.

In conventional case management systems, multiple users are permitted to store and edit electronic case files on a closed client/server architecture, such as a local area network or a wide area network. With the recent rapid expansion of the Internet, the opportunity for collaborative efforts has greatly increased. Colleagues scattered around the world can rapidly transmit case files for editing and revision using electronic mail facilities.

Electronic mail systems are useful for transmitting relatively small case files over an intranet or the Internet. However, larger case files are often too large to be handled by typical message transfer systems, and can overburden a network. Large case files also may exceed the available storage at a recipient's site, thus preventing the recipient from storing the received case file. Additionally, electronic mail systems used on open systems such as the Internet generally do not address security concerns or permit tracking of a transmission. These advantages are only available if a hardcopy file delivery service is used. Furthermore, the editing and revision of electronic case files becomes exponentially more difficult as the number of editors in an edit process is increased. In particular, a user's access to a case file may not be limited to the particular occasion when the user is required to work on the case file. This can lead to mistakes and mishandling of the case file.

Accordingly, it is desired to provide a case editing system and method which overcomes the above-described problems.

### SUMMARY OF THE INVENTION

It is an objective of the present invention to provide a case editing system and method which readily enables editors to edit case files and writers to revise the case files, especially when the editors and writers are located at different places.

It is another objective of the present invention to provide a case editing system and method which limits each user's access to a case files to the particular occasion when the user is required to work on the case file.

To accomplish the above objectives, a case editing system in accordance with a preferred embodiment of the present invention comprises: a database server for storing a plurality of case files, an edit process file and an edit record file; an application server; and a plurality of client computers for providing an interactive edit interface for corresponding users to carry out case edit operations. The application server comprises a case uploading module for uploading case files to the database server; an authority management module for assigning and canceling access authorities of the case files with respect to different editors and writers; a case editing module for enabling editors to edit the case files and record edit results in the edit record file; and a case revising module for enabling writers to revise the case files and determine whether revision of each case file is complete.

Further, a case editing method according to the present invention comprises the following steps: uploading a case file to a database server and selecting a corresponding edit process; transmitting a message to a first editor of the selected edit process advising the editor of the need for editing the case file and assigning the access authority of the case file for the editor; editing the case file; recording edit results in an edit record file and canceling the access authority of the case file for the editor; determining whether the case file is a satisfactory file; and determining whether the case file has been edited by all editors included in the selected edit process.

Other objects, novel features and advantages of the present invention will be drawn from the following detailed description of the invention with the attached drawings, in which:

### BRIEF DESCRIPTION OF THE DRAWINGS

FIG. 1 is a schematic diagram of an application environment of the case editing system in accordance with the preferred embodiment of the present invention, the system comprising a database server and an application server;

FIG. 2 is a schematic diagram of main software function modules of the application server, and of files stored in the database server of the system of FIG. 1; and

FIG. 3 is a flowchart of a preferred case editing method in accordance with the present invention, utilizing the case editing system of FIG. 1.

### DETAILED DESCRIPTION OF THE INVENTION

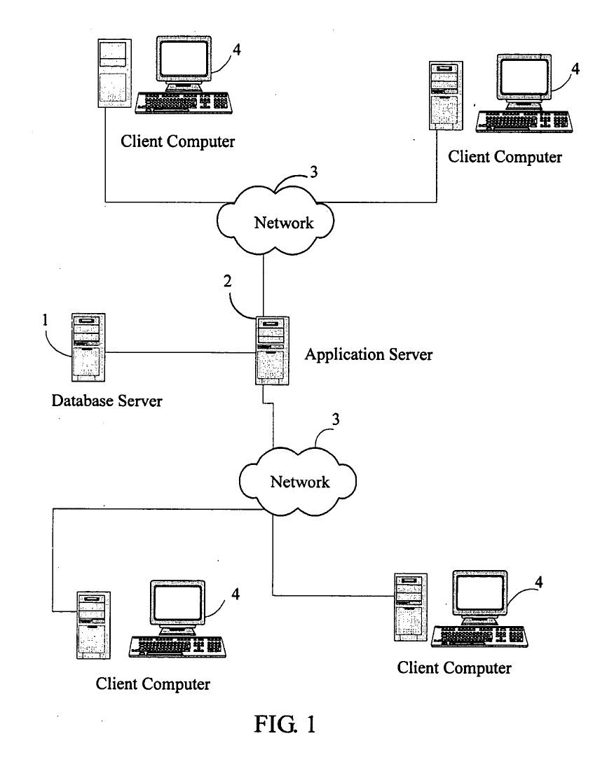

FIG. 1 is a schematic diagram of hardware configuration of a case editing system in accordance with the preferred embodiment of the present invention. The case editing system comprises a database server 1, an application server 2, a communication network 3, and a plurality of client computers 4. The database server 1 is connected with the application server 2 via a database connection (not shown). The client computers 4 are located at different places of an organization, and are connected with the application server 2 via the network 3. The network 3 may be an intranet, the Internet, or any other suitable communication networks.

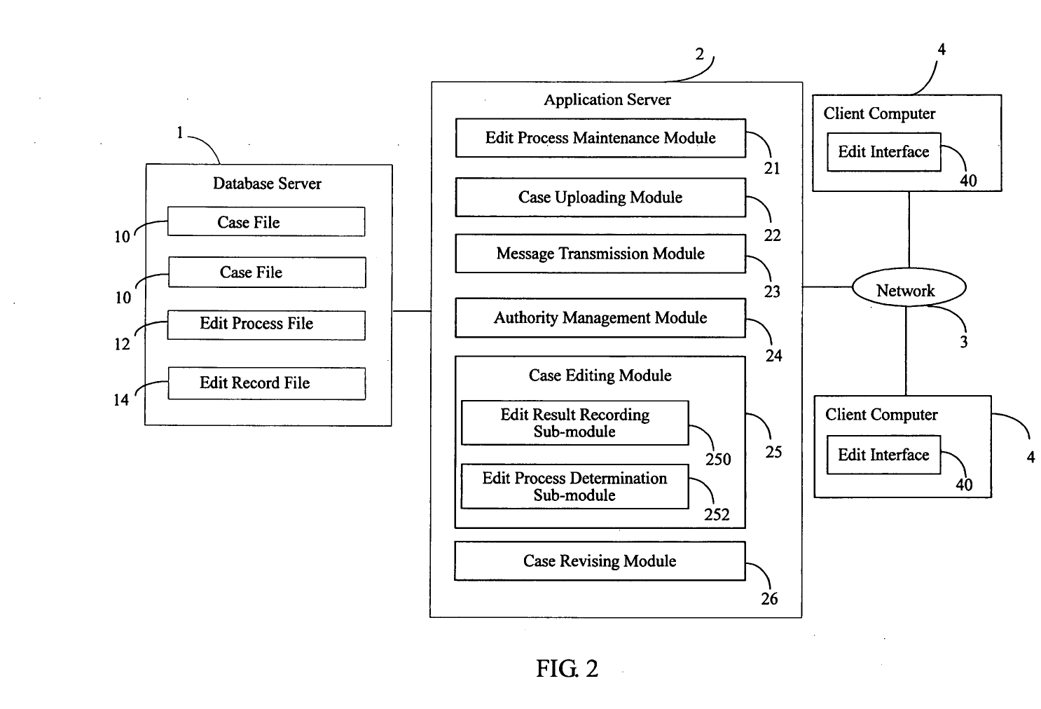

FIG. 2 is a schematic diagram of function modules of the application server 2 and files stored in the database server 1. The database server 1 stores files used or generated in implementing the case editing system. Such files comprise a plurality of case files 10 (only two shown), an edit process file 12, and an edit record file 14. The case files 10 may be professional files, and may be text format and/or graphic format files. Professional files may for example comprise commercial documents and legal documents.

The edit process file 12 stores information on edit processes. Each edit process includes at least one participating editor. The information on each edit process includes a sequence of editing by editors in the edit process, and basic information on the editors. The basic information on each editor includes a name and an e-mail address of the editor. The edit record file 14 stores edit results determined by an editor. The edit results may indicate whether a case file 10 is a satisfactory file or an unsatisfactory file. If a case file 10 is not a satisfactory file, the edit results further include contents of the case file 10 that need to be revised.

The application server 2 is for maintaining edit processes, for assigning access authorities to different editors and writers, for transmitting messages to the above-mentioned editors and writers, for enabling the editors to edit the case files 10, for recording edit results in the edit record file 14, and for enabling the writers to revise the case files 10. In this description, the access authority of each case file 10 is unique, and is assigned to different editors and the writer of the case file 10 at respective different times. That is, in order to prevent two or more users accessing a same case file 10 at a particular time, the access authority of the case file 10 can only be assigned to a single writer or a single editor at any given time. The assignment of the access authority at any particular time is determined according to an edit process selected by the writer of the case file 10 at the time the case file 10 is first created. For example, when the access authority of the case file 10 is assigned to a particular editor who is required to edit the case file 10, the writer of the case file 10 and the other editors of the selected edit process can-not access the case file 10 at this same time.

The application server 2 comprises an edit process maintenance module 21, a case uploading module 22, a message transmission module 23, an authority management module 24, a case editing module 25, and a case revising module 26. The edit process maintenance module 21 is used for adding, creating, deleting and modifying edit processes, and for updating the edit process file 12. The case uploading module 22 uploads the case files 10 that need to be edited and revised to the database server 1. The message transmission module 23 is used for transmitting a message to a corresponding editor to advise the editor of the need for editing a corresponding case file 10, and for transmitting a message to a corresponding writer to advise the writer of the need for revising a corresponding case file 10 if the case file 10 is not a satisfactory file. The authority management module 24 manages access authorities of the case files 10, and assigns and cancels the access authority of each case file 10 to the corresponding writer and the corresponding editor as needed. The case editing module 25 comprises an edit result recording sub-module 250, and an edit process determination sub-module 252. The case editing module 25 is provided for editors to edit case files 10, and for recording edit results in the edit record file 14. The edit recording sub-module 250 is used for recording edit results in the edit record file 14, and for determining whether a case file 10 is a satisfactory file or an unsatisfactory file based on the edit record file 14. If a case file 10 is not a satisfactory file, the edit recording sub-module 250 further records the contents of the case file 10 that need to be revised. The edit process determination sub-module 252 is for determining whether a case file 10 has been edited by all editors included in a selected edit process according to the edit process file 12. The case revising module 26 is used for a writer to revise a case file 10 through the applicable client computer 4 if the case file 10 is not a satisfactory file.

Each client computer 4 located at a particular place of the organization is provided for corresponding users of the case editing system to carry out case editing operations. Each client computer 4 provides an interactive edit interface 40, which includes a dropdown menu for writers to select an edit process from a predetermined edit process list therein.

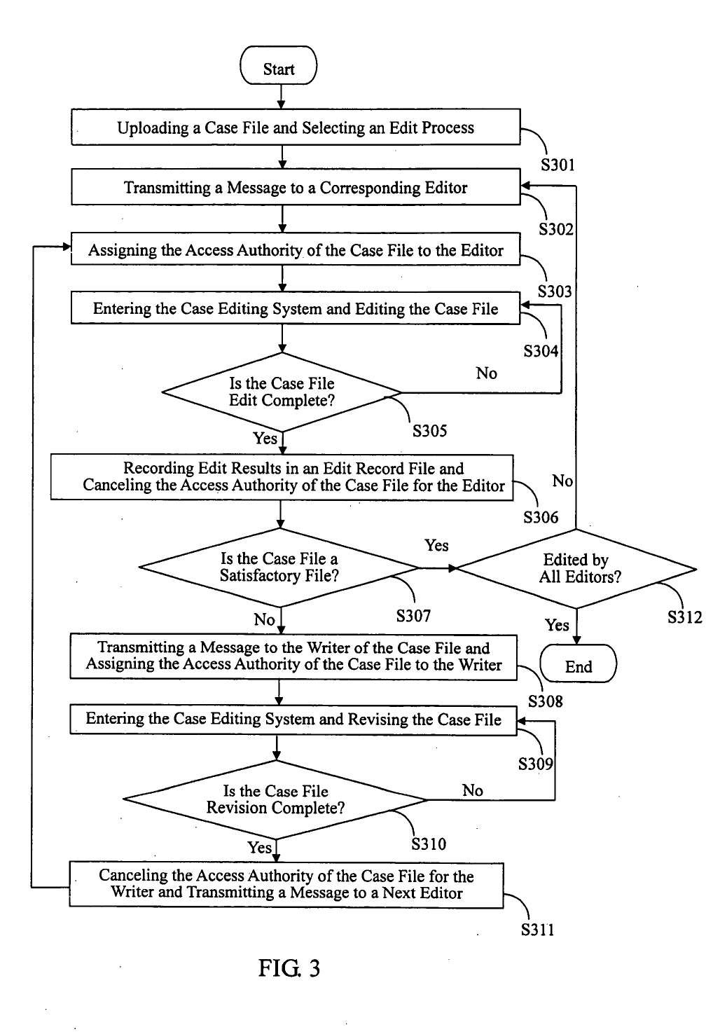

FIG. 3 is a flowchart of the preferred case editing method in accordance with the present invention, utilizing the case editing system described above. In step S301, the case uploading module 22 uploads a case file 10 that needs to be edited to the database server 1. The writer of the case file 10 selects a corresponding edit process for the case file 10 through an edit interface 40. The edit process maintenance module 21 can also add, create, delete and modify the edit process, and update the edit process file 12 stored in the database server 1. In step S302, the message transmission module 23 transmits a message to a first editor in the selected edit process advising the editor of the need for editing the case file 10. In step S303, the authority management module 24 assigns the access authority of the case file 10 to the first editor. In step S304, the editor enters the case editing system through an edit interface 40, and edits the case file 10 through the case editing module 25. In step S305, the editor determines whether the case file edit is complete. If the case file edit is not complete, the procedure returns to step S304, and the editor continues editing the case file 10. If and when the case file edit is complete, in step S306, the edit result recording sub-module 250 records edit results in the edit record file 14, and the authority management module 24 cancels the access authority of the case file 10 for the first editor. In step S307, the case editing module 25 determines whether the case file 10 is a satisfactory file based on the edit record file 14. If the case file 10 is not a satisfactory file, in step S308, the message transmission module 23 transmits a message to the writer of the case file 10 advising the writer of the need for revising the case file 10, and the authority management module 24 assigns the access authority of the case file 10 to the writer. In step S309, the writer enters the case editing system through the edit interface 40, and revises the case file 10 through the case revising module 26. In step S310, the writer determines whether the case file revision is complete. If the case file revision is not complete, the procedure returns to step S309, and the writer continues revising the case file 10. If and when the case file revision is complete, in step S311, the authority management module 24 cancels the access authority of the case file 10 for the writer, and the message transmission module 23 transmits a message to a next editor advising the next editor of the need for editing the revised case file 10. Thereupon, the procedure returns to step S303 in respect of the next editor.

If the case file 10 is a satisfactory file, in step S312, the edit process determination sub-module 252 determines whether the case file 10 has been edited by all editors included in the selected edit process according to the edit process file 12. If the case file 10 has not been edited by all the editors included in the selected edit process, the procedure returns to step S302. That is, the message transmission module 23 transmits a message to a next editor of the selected edit process to further edit the case file 10. If the case file 10 has been edited by all the editors included in the selected edit process, the procedure is ended.

Although the present invention has been specifically described on the basis of a preferred embodiment and preferred method, the invention is not to be construed as being limited thereto. Various changes or modifications may be made to said embodiment and methods without departing from the scope and spirit of the invention.

What is claimed is:

1. A case editing system for providing editing services over a network environment, the case editing system comprising:
a database server for storing a plurality of case files, an edit process file and an edit record file;
an application server comprising:
a case uploading module for uploading case files to the database server;
an authority management module for assigning and canceling access authorities of the case files to different editors and writers;
a case editing module for enabling editors to edit the case files, determine whether editing of each case file is complete, and record edit results in the edit record file, and for determining whether each case file is a satisfactory file; and
a case revising module for enabling writers to revise the case files, and determine whether revision of each case file is complete; and
a plurality of client computers, each of the client computers providing an interactive edit interface for corresponding users of the case editing system to carry out case edit operations.

2. The case editing system according to claim 1, wherein the edit process file is for storing information on edit processes, the information on each edit process comprising a sequence of editing by editors in the edit process and basic information on the editors.

3. The case editing system according to claim 1, wherein the edit record file records edit results, the edit results comprising information indicating whether a case file is a satisfactory file or an unsatisfactory file.

4. The case editing system according to claim 3, wherein the edit results further comprise contents of the case file that need to be revised if the case file is an unsatisfactory file.

5. The case editing system according to claim 1, wherein the application server further comprises an edit process maintenance module for adding, creating, deleting and modifying the edit processes.

6. The case editing system according to claim 1, wherein the application server further comprises a message transmission module for transmitting messages to various editors and writers.

7. The case editing system according to claim 1, wherein the case editing module comprises an edit result recording sub-module for recording edit results in the edit record file.

8. The case editing system according to claim 1, wherein the case editing module further comprises an edit process determination sub-module for determining whether a case file has been edited by all editors included in a selected edit process.

9. A computer-based case editing method implemented by a case editing system comprising a database server, an application server and a plurality of client computers, the method comprising the steps of:
uploading a case file to the database server and selecting a corresponding edit process for the case file;
transmitting a message to a corresponding editor advising the editor of the need for editing the case file and assigning the access authority of the case file to the editor;
editing the case file;
recording edit results in an edit record file and canceling the access authority of the case file for the editor;
determining whether the case file is a satisfactory file based on the edit record file; and
determining whether the case file has been edited by all editors included in the selected edit process if the case file is a satisfactory file.

10. The case editing method according to claim 9, further comprising the step of determining whether editing of the case file by the editor is complete.

11. The case editing method according to claim 10, further comprising the step of continuing to edit the case file again if editing of the case file by the editor is not complete.

12. The case editing method according to claim 9, further comprising the step of transmitting a message to the writer of the case file advising the writer of the need for revising the case file and assigning the access authority of the case file to the writer if the case file is not a satisfactory file.

13. The case editing method according to claim 12, further comprising the step of revising the case file.

14. The case editing method according to claim 13, further comprising the step of determining whether revision of the case file is complete.

15. The case editing method according to claim 14, further comprising the step of continuing to revise the case file if revision of the case file is not complete.

16. The case editing method according to claim 14, further comprising the step of canceling the access authority of the case file for the writer and transmitting a message to a next editor advising the editor of the need for editing the case file if revision of the case file is complete.

17. The case editing method according to claim 9, further comprising the step of transmitting a message to a next editor of the selected edit process advising the editor of the need for editing the case file if the case file has not been edited by all editors included in the selected edit process.

18. An interaction communication arrangement between a document drafter and at least one editor through a computer-based system for a document, comprising steps of:
(A) the document drafter finishing a draft of the document and uploading said draft to a system;
(B) the system canceling an access authority of said draft from the drafter, and notifying said at least one editor and assigning an access authority of said draft to said at least one editor;
(C) the at least one editor uploading an edited draft to the system after edition has been done;
(D) the system canceling the access authority of said edited draft from said at least one editor;
(E) the system notifying the drafter and assigning an access authority of said edited draft to said draft to allow the drafter to revise the edited draft and resubmit a revised draft to the same at least one editor if the edited draft is requested by the at least one editor to be further drafted by said drafter;
(F) otherwise the system notifying another editor being of a higher level relative to said at least one editor and assigning an access authority of said edited draft to said anther editor for further edition if the edited draft is okay with said at least one editor and if the edited draft is designated to be reviewed by said another editor; and
(G) an interaction between said drafter and said at least one editor repeating steps (A)-(E) via said system, or further with said another editor repeating steps (A)-(F) in a level-by-level manner if more than one levels edition are required, until a final version of the draft is completely okay with a corresponding editor who is designated to be a highest level editor of said document.
